(19) United States
(12) Patent Application Publication
(10) Pub. No.: US 2022/0083426 A1
(43) Pub. Date: Mar. 17, 2022

(54) METHOD AND SYSTEM FOR HYBRID INCREMENTAL FILE-BASED BACKUPS

(71) Applicant: EMC IP Holding Company LLC, Hopkinton, MA (US)

(72) Inventors: Shelesh Chopra, Bangalore (IN); Sunil Yadav, Bangalore (IN); Manish Sharma, Bangalore (IN); Aaditya Rakesh Bansal, Bangalore (IN)

(21) Appl. No.: 17/020,964

(22) Filed: Sep. 15, 2020

(51) Int. Cl. G06F 11/14

(52) U.S. Cl. CPC G06F 11/1451; G06F 2201/82; G06F 2201/80

(57) ABSTRACT

A method and system for hybrid incremental file-based backup that includes receiving a list of desired elements for incremental backup and determining the elements on the list of desired elements that have changed since a previous backup, and storing the elements on the list of desired elements that have changed since the previous backup in a backup container. The method and system determines a list of unchanged elements from the previous backup and storing the unchanged elements on the list of unchanged elements in the backup container to obtain an updated backup.

### BACKGROUND

Computing devices may include any number of internal components such as processors, memory, and persistent storage. Each of the internal components of a computing device may be used to generate data. The process of generating, storing, and scheduling data may utilize computing resources of the computing devices such as processing and storage. The utilization of the aforementioned computing resources to generate backups may impact the overall performance of the computing resources.

### SUMMARY

In general, in one aspect, the invention relates to a method for hybrid incremental file-based backup that includes receiving a list of desired elements for incremental backup and determining the elements on the list of desired elements that have changed since a previous backup, and storing the elements on the list of desired elements that have changed since the previous backup in a backup container. The method also includes determining a list of unchanged elements from the previous backup and storing the unchanged elements on the list of unchanged elements in the backup container to obtain an updated backup.

In another aspect, the invention relates to a system for incremental backup that includes a backup agent that receives a list of desired elements for incremental backup, determines the elements on the list of desired elements that have changed since a previous backup, and initiates a transfer of the desired elements that have changed since the previous backup. The system also includes a backup storage device that receives the desired elements that have changed since the previous backup, stores the elements on the list of desired elements that have changed since the previous backup in a backup container. The backup storage device also determines a list of unchanged elements from the previous backup and storing the unchanged elements on the list of unchanged elements in the backup container to obtain an updated backup.

In another aspect, the invention relates to a non-transitory computer readable medium that includes computer readable program code, which when executed by a computer processor enables the computer processor to perform a method for hybrid incremental file-based backup that includes receiving a list of desired elements for incremental backup, determining the elements on the list of desired elements that have changed since a previous backup, and storing the elements on the list of desired elements that have changed since the previous backup in a backup container. The computer readable medium also determines a list of unchanged elements from the previous backup and stores the unchanged elements on the list of unchanged elements in the backup container to obtain an updated backup.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a system in accordance with one or more embodiments of the invention.

FIG. 2 describes a backup storage device in accordance with one or more embodiments disclosed herein.

FIGS. 3A and 3B show flowcharts for operations in accordance with one or more embodiments of the invention.

FIG. 4 shows a flowchart for operations in accordance with one or more embodiments of the invention.

FIG. 5 shows a diagram of a computing device in accordance with one or more embodiments of the invention.

FIGS. 6A, 6B, 6C, 6D, and 6E demonstrate an example in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N, A to P, A to M, or A to L. As used herein, the aforementioned labeling means that the element may include any number of items and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to processing jobs associated with backup operations. More specifically, embodiments may provide an incremental hybrid system for a custom tailored synthetic backup. In one or more embodiments disclosed herein, it is not necessary to crawl through, or interrogate, directories of files in multiple production hosts to obtain the desired backup. Embodiments may provide the advantage of ignoring redundant changes, for example in temp log files, system files, etc. Embodiments may also provide for optimized network usage in backup operations. Embodiments may be particularly advantageous in cloud-based backups; however, the embodiments of the invention are not limited to this use case.

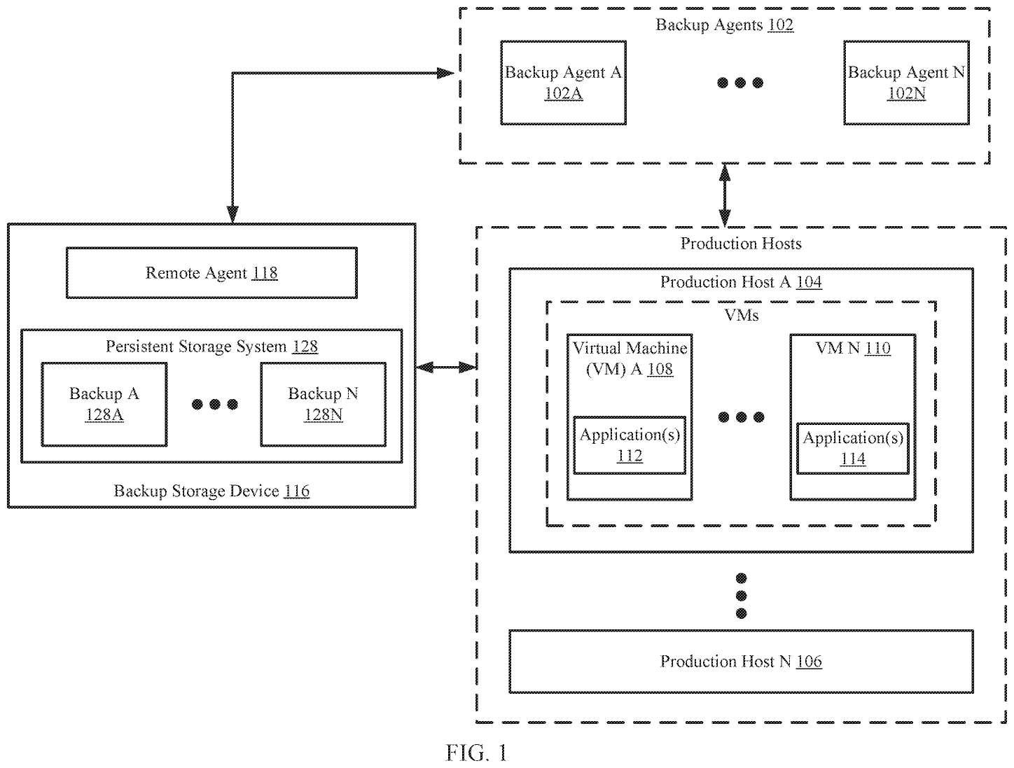

FIG. 1 shows an example system in accordance with one or more embodiments of the invention. The system includes backup agents (102A . . . 102N), production hosts (104, 106), and a backup storage device (116). The system may include additional, fewer, and/or different components without departing from the invention. Each component may be operably connected via any combination of wired and/or wireless connections. Each component illustrated in FIG. 1 is discussed below.

In one or more embodiments of the invention, the backup agents (102A . . . 102N) perform backup operations of virtual machines. The backup agents (102A . . . 102N) may each perform a backup operation as assigned by the backup storage system. The backup operation may include obtaining data associated with a virtual machine (VM) or application and generating a copy of the data and storing it in a backup format in the backup storage system. The backup agents may perform backup operations in accordance with the jobs described herein. The backup agents may include functionality to obtain the backup properties (described below) for the backup jobs associated with a given production host and/or virtual machine. While the backup agents are shown as being external to the production hosts, the backup agents may reside on the production hosts and/or within the virtual machines on the production hosts without departing from the invention.

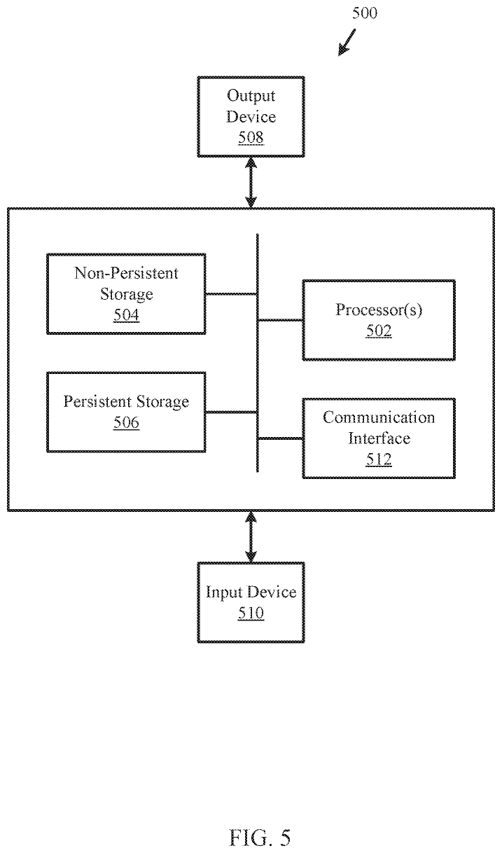

In one or more embodiments of the invention, the backup agents (102A . . . 102N) are implemented as computing devices (see e.g., FIG. 5). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the backup agent described throughout this application and/or all, or a portion thereof.

In one or more embodiments of the invention, the backup agents (102A . . . 102N) are implemented as a logical device. The logical device may utilize the computing resources of any number of computing devices and thereby provide the functionality of the backup agents.

In one or more embodiments of the invention, the production hosts (104, 106) may host virtual machines (VMs) (108, 110). The virtual machines (108, 110) may be logical entities executed using computing resources (not shown) of the production hosts. Each of the virtual machines (108, 110) may be performing similar or different processes. In one or more embodiments of the invention, the virtual machines (108, 110) provide services to users, e.g., clients (not shown). For example, the virtual machines (108, 110) may host instances of databases, email servers, and/or other applications (112, 114). The virtual machines may host other types of applications without departing from the invention.

In one or more of embodiments of the invention, the virtual machines (108, 110) are implemented as computer instructions, e.g., computer code, stored on a persistent storage (e.g., on a production host)) that when executed by a processor(s) of the production host cause the production host to provide the functionality of the virtual machines.

In one or more embodiments of the invention, the production host (104, 106) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host described throughout this application.

In one or more embodiments of the invention, the production host (104, 106) is implemented as a logical device. The logical device may utilize the computing resources of any number of computing devices and thereby provide the functionality of the production host described throughout this application.

In one or more embodiments of the invention, the backup storage device (116) may manage the backups of virtual machines (108, 110) hosted by the production hosts (104, 106). The backup storage device (116) may manage the backups by performing jobs in orchestration with the backup agents (102A . . . 102N).

The backup storage device (116) may include additional, fewer, and/or different components without departing from the invention. Each component of the backup storage device (116) is discussed below.

In one or more embodiments of the invention, the backup storage device (116) includes a remote agent (118) that obtains and stores policy level details and critical tags on jobs to be performed. The policy engine also communicates, or monitors, the status of jobs from the backup agents (102A . . . 102N).

In one or more embodiments of the invention, remote agent (118) is a hardware device including circuitry. The remote agent (118) may be, for example, a digital signal processor, a field programmable gate array, or an application specific integrated circuit. The remote agent (118) may be other types of hardware devices without departing from the invention.

In one or more embodiments of the invention, the remote agent (118) is implemented as computing code stored on a persistent storage that when executed by a processor of the backup storage system (116) performs the functionality of remote agent (118). The processor may be a hardware processor including circuitry such as, for example, a central processing unit or a microcontroller. The processor may be other types of hardware devices for processing digital information without departing from the invention.

In one or more embodiments of the invention, the backup storage device (116) may include a persistent storage system (128), which is a system of persistent storage devices that store any number of backups (128A, 128N). In one or more embodiments of the invention, a backup (128A, 128N) is a copy of data associated with a virtual machine. The backup (128A, 128N) may include references to the data that may be used to access the data from the persistent storage system (128). A backup may further include additional data that enables the backup storage device (116) to restore a virtual machine (or a portion of data associated with the virtual machine) associated with the backup from any production host (104, 106). One of ordinary skill in the art will appreciate that the persistent storage system (128) may be a separate entity in a different location than the separately from the backup storage system (116).

In one or more embodiments of the invention, each of the persistent storage system (128) includes magnetic memory devices, optical memory devices, solid state memory devices, phase change memory devices, any other suitable type of persistent memory device, or any combination thereof.

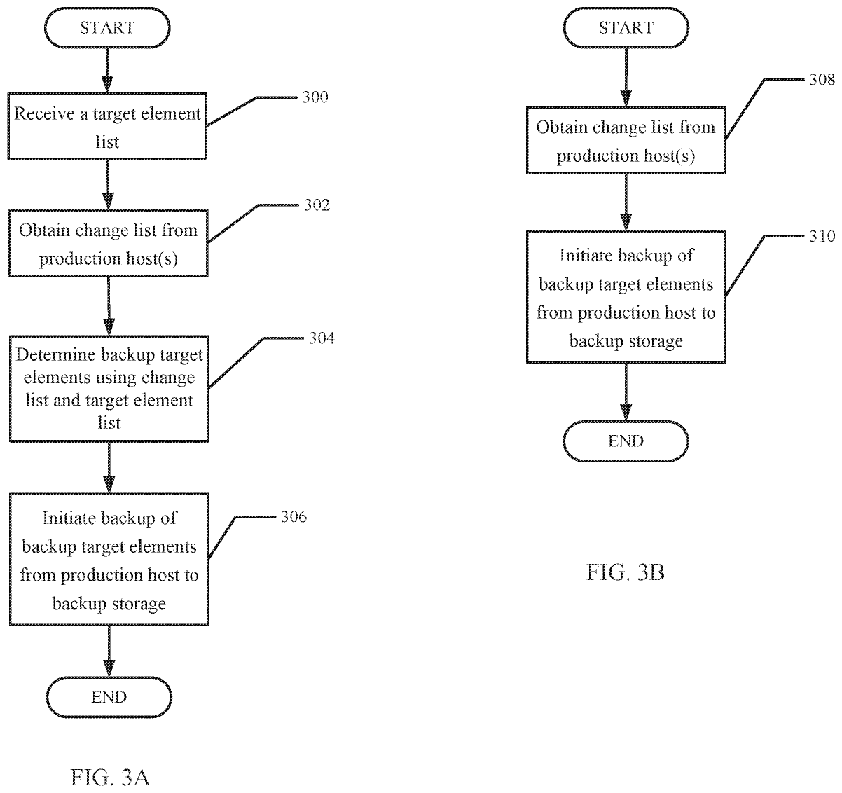

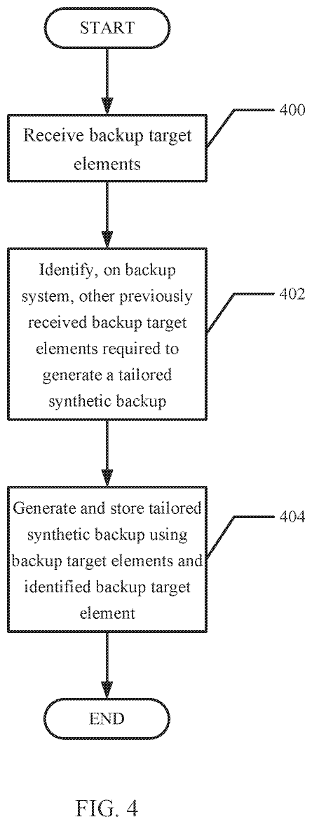

In one or more embodiments, the backup storage system (116) is responsible for the embodiments described in FIG. 4 below. One of ordinary skill in the art will appreciate that the backup storage system (116) may also perform one or more steps of FIGS. 3A and 3B without departing from the spirit of embodiments disclosed herein.

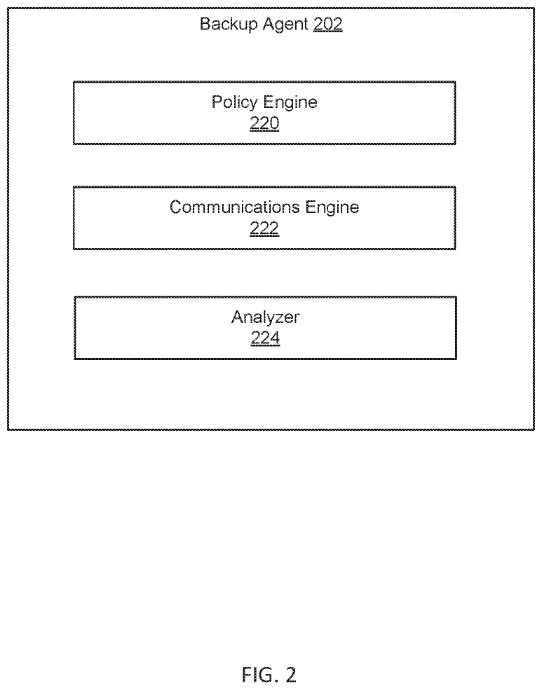

FIG. 2 describes the backup agent (202) in accordance with one or more embodiments disclosed herein. The backup storage device (200) includes a policy engine (220), a communications engine (222), and an analyzer (224). The backup storage agent (202) may include additional, fewer, and/or different components without departing from the invention.

In one or more embodiments, the policy engine (220) stores and maintains the policies to be performed (or otherwise implemented or followed) by the backup storage device (202). The communications engine (222) is responsible for communications to and from the backup storage device (202), for example, with the production hosts (104, 106) and backup storage device (116). In one or more embodiments, the analyzer (224) is responsible for analyzing data to determined compliance of the policies associated with the policy engine (220).

In one or more embodiments, the backup agent (202) is responsible for embodiments of the methods described in FIGS. 3A and 3B. One of ordinary skill in the art will appreciate that the backup agent (202) may also perform one or more of the steps of FIG. 4 without departing from the spirit of embodiments disclosed herein.

In one or more embodiments of the invention, the backup agent (202) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the backup storage device described throughout this application.

In one or more embodiments, as part of an incremental backup, a backup agent may receive a list of updated/changed elements. In other embodiments disclosed herein, the backup agent may receive a list of target elements to be considered for the incremental backup. In some embodiments, hash information of the specified target elements may be compared to metadata information (e.g., attribute information, location information, and hash information) of a previous backup to determine if such target elements need to backed up. In one or more embodiments disclosed herein, a combination of the above may be used to determine which desired elements need to be backed up to complete the tailored synthetic backup. In one embodiment of the invention, the target element may be a file, a folder, and/or a directory. The target element includes all content therein. For example, if the target element is a folder and the folder includes two files and a subfolder (which includes additional files), the target element includes the two files, the subfolder (and all of the files stored therein).

FIG. 3A describes a method in accordance with one or more embodiments disclosed herein. Embodiments of FIG. 3A may be performed by the backup agent (202) described herein. Other components of the system in FIG. 1 may perform all, or a portion, of the method of FIG. 3A without departing from the invention.

While FIG. 3A is illustrated as a series of steps, any of the steps may be omitted, performed in a different order, additional steps may be included, and/or any or all of the steps may be performed in a parallel and/or partially overlapping manner without departing from the invention.

In step 300, a target element list is received. The target element list may be stored in the policy engine (220) and received via the communications engine (222) of the backup agent (202). In some embodiments, the target element list may be received from the remote agent (118) of the backup storage device (116). The target element list may represent a custom list of desired elements to be backup up specified by a client or administrator of the system.

In step 302, a change list of elements is obtained from one or more production hosts. The change list may represent a list of elements of a production host that has changed since a previous backup. The change list may specify files, folders, and/or directories that have changed. The granularity of the change list may vary based on the implementation of the various embodiments of the invention.

In step 304, the backup target elements to be backup up are determined using the target element list and the change list. The analyzer (224) of the backup agent (202) may make such determinations. For example, the backup target elements may correspond to the intersection between the target element list and the change list. Said another way, the backup target elements may be the elements on the target element list that have been identified as being changed as evidenced by their presence on the change list.

In one embodiment of the invention, the change list and the target element list are both specified at the same level of granularity.

In step 306, a backup of the backup target elements is initiated from the production host to the backup storage. In some embodiments, the backup of the backup target elements from the production host to the backup storage may be performed via the backup agent (202). In other embodiments, the backup of the backup target elements may be performed directly from the production hosts (104, 106) to the backup storage device (116).

FIG. 3B describes a method in accordance with one or more embodiments disclosed herein. Embodiments of FIG. 3B may be performed by the backup agent (202) described herein. Other components of the system in FIG. 1 may perform all, or a portion, of the method of FIG. 3B without departing from the invention.

While FIG. 3B is illustrated as a series of steps, any of the steps may be omitted, performed in a different order, additional steps may be included, and/or any or all of the steps may be performed in a parallel and/or partially overlapping manner without departing from the invention.

In step 308, a change list of elements is obtained from the production hosts. In some embodiments, the change list may only include those desired elements to be backed up in the custom backup. For example, the production host may be programmed, via the backup agent, to obtain only those elements desired to be backed up that have changed since a previous backup.

In step 310, a backup of the backup target elements is initiated from the production host to the backup storage. In some embodiments, the backup of the backup target elements from the production host to the backup storage may be performed via the backup agent (202). In other embodiments, the backup of the backup target elements may be performed directly from the production hosts (104, 106) to the backup storage device (116).

FIG. 4 demonstrates a method in accordance with one or more embodiments disclosed herein. Embodiments of FIG. 4 may be performed by the backup storage device (116). Other components of the system in FIG. 1 may perform all, or a portion, of the method of FIG. 4 without departing from the invention. Embodiments of FIG. 4 may be performed after that of the embodiments of FIGS. 3A and/or 3B.

While FIG. 4 is illustrated as a series of steps, any of the steps may be omitted, performed in a different order, additional steps may be included, and/or any or all of the steps may be performed in a parallel and/or partially overlapping manner without departing from the invention.

In step 400, backup target elements are received. As described above, the backup target elements maybe received from the backup agent (202) or the production hosts (104, 106) in accordance with embodiments disclosed herein.

In step 402, other previous received elements during a backup process that are required to generate a complete tailored synthetic backup are identified. For example, a previous backup may be used to identify elements not included in the desired target backup elements in the backup storage device (116).

In step 404, a tailored synthetic backup using the backup target elements received in step 400 and the other identified backup target elements identified in step 402 is generated and stored. In other words, the specific desired elements are backed up from the production host and combined with other elements from one or more previous backups. The specific desired elements may be combined using metadata information, without any further data transfer from the production host. In one embodiment of the invention, the tailored synthetic backup includes current versions of content that is specified on the target element list and older versions of the content for elements not on the target element list. Thus, unlike traditional synthetic backup generation where the synthetic backup that is generated includes the same content as if a full backup had been created at a particular point in time, tailored synthetic backups includes the current version of the target elements (i.e., as if a full backup had just been performed on the target elements) and older content for all non-target elements.

The processing in Step 404, results in a customer tailored synthetic backup associated with the production hosts with only the desired elements updated. Such backups may be performed faster with less computation cost than traditional backup mechanisms. Furthermore, such backups do not require crawling through the production hosts during the backup process.

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the backup storage device and/or backup agents. Further, such instructions may correspond to computer readable instructions that are stored on one or more non-transitory computer readable mediums.

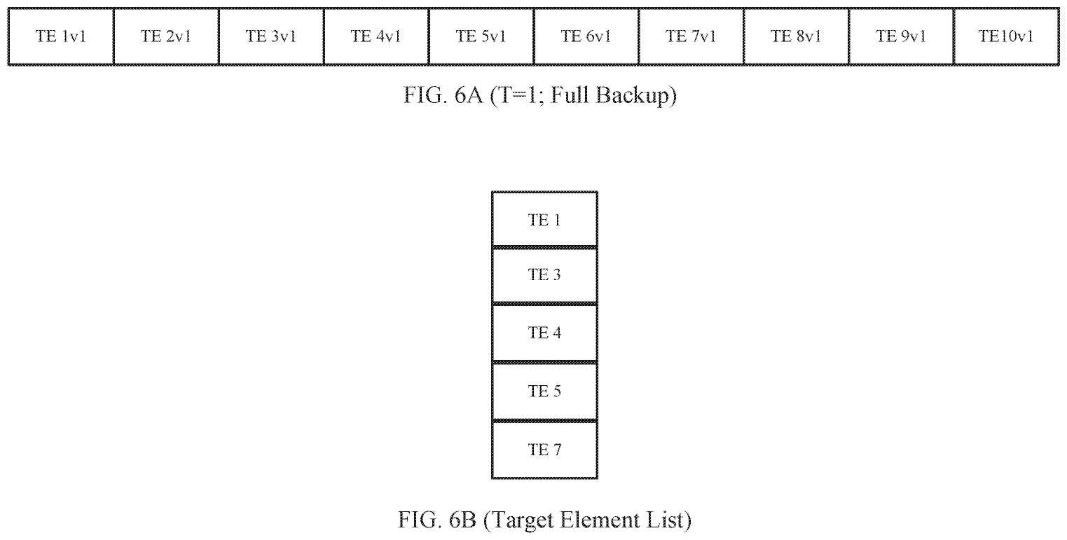

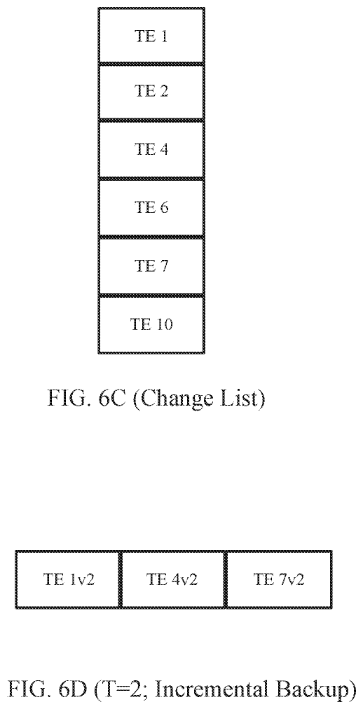

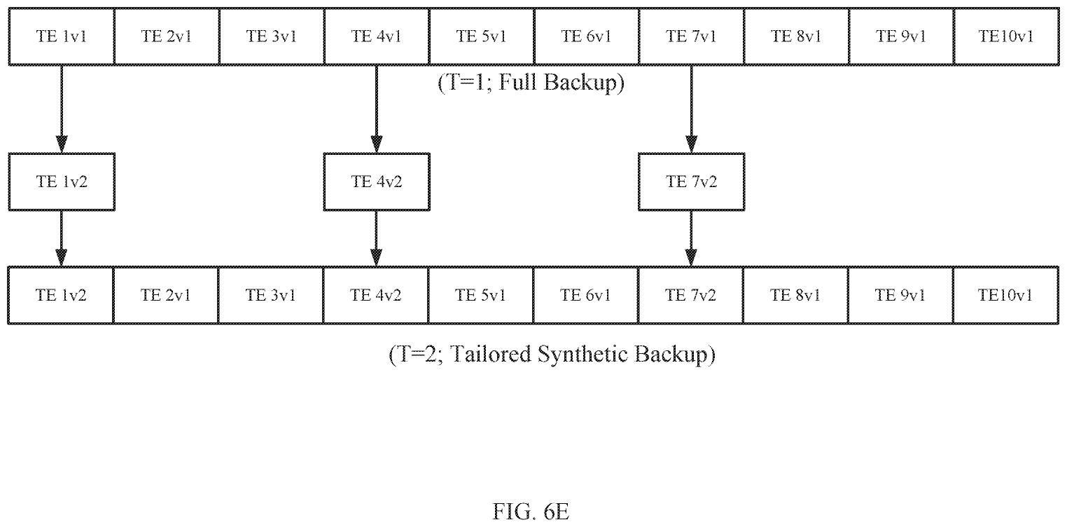

FIGS. 6A, 6B, 6C, 6D, and 6E demonstrate an example in accordance with one or more embodiments of the invention. Embodiments disclosed herein are not limited to the examples of FIGS. 6A-6E.

Turning to the example, FIG. 6A demonstrates a full backup at a time T=1. In the example, the full backup includes a first version of ten target elements (TE 1v1 . . . TE 10v1). FIG. 6B shows an example of a target element list. In the example of FIG. 6B, the target element list includes TE 1, TE 3, TE 4, TE 5, and TE 7. The target element list includes the desired elements to be backed up that has been established in the system in accordance with one or more embodiments disclosed herein.

FIG. 6C demonstrates a change list in accordance with one or more embodiments disclosed herein. The change list include those elements of the production host that have changed since a previous backup in accordance with embodiments described above. In the example of FIG. 6C, the target elements TE 1, TE 2, TE 4, TE 6, TE 7, and TE 10 are listed. As previous described in FIG. 3A, the target elements of FIG. 6D may be determined by comparing the list of FIG. 6B to that of FIG. 6C. More specifically, it is determined that target elements TE 1, TE 4, and TE 7 are the desired target elements to be backed up—i.e., because these elements are present on the change list. These elements may then be backed up to the backup storage device (116) as described above. This results in the incremental backup of an updated version of the target elements (TE 1v2, TE 4v2, and TE 7v2) at a later time T=2 demonstrated by FIG. 6D.

FIG. 6E demonstrates generating and storing a tailored synthetic backup in accordance with one or more embodiments disclosed herein. As described in FIG. 4, the target elements not desired are established from the previous backup at a time T=1. In this example, the target elements TE v1, TE 3v1, TE 5v1, TE 6v1, TE 8v1, TE 9v1, and TE 10v1 are obtained from the tailored backup at T=1. As shown in FIG. 6E, a complete tailored synthetic backup is generated and stored at a time T=2 by replacing the updated desired target elements with the elements from a previous backup that were not desired.

Embodiments disclosed herein provide an incremental hybrid system for a custom tailored synthetic backup. Embodiments disclosed herein provide a backup system that does not require crawling through, or interrogating, directories of files in multiple production hosts to identify elements that have changed. Embodiments may provide the advantage of ignoring redundant/undesired changes, such as temp log files and/or system files. Embodiments may also provide for optimized network usage for custom backup operations. As previous noted, embodiments may be particularly advantageous in cloud-based backups. Embodiments disclosed herein shorten the time and resources needed to store a full backup as less data needs to be transferred over the network.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for hybrid incremental file-based backup, the method comprising:
receiving a list of desired elements for incremental backup;
determining elements on the list of desired elements that have changed since a previous backup;
storing the elements on the list of desired elements that have changed since the previous backup in a backup container;
determining a list of unchanged elements from the previous backup; and
storing unchanged elements on the list of unchanged elements in the backup container to obtain a tailored synthetic backup.

2. The method of claim 1, wherein determining the elements on the list of desired elements that have changed since the previous backup comprises:
receiving a list of changed elements; and
determine the elements on the list of desired elements that have changed by comparing the list of desired elements to the list of changed elements.

3. The method of claim 2, wherein the list of all changed elements is generated by a host, wherein the host is operatively connected to a backup storage, wherein the backup container is located on the backup storage.

4. The method of claim 3, wherein the list of all changed elements specifies at least one file.

5. The method of claim 1, wherein determining the elements on the list of desired elements that have changed since the previous backup comprises:
obtaining current metadata associated with each of the elements on the list of desired elements; and
comparing the current metadata for each element on the list of desired elements to metadata for each element in the previous backup.

6. The method of claim 5, wherein the metadata comprises at least one selected from a group consisting of attribute information, location information, and hash information.

7. The method of claim 6, wherein the hash information is used to determine elements on the list of desired elements that have changed since the previous backup.

8. The method of claim 1, wherein the previous back up is a most recent successful full backup.

9. A system for incremental backup, the system comprising:
a backup agent configured to:
receive, from a production host, a list of desired elements for incremental backup;
determine elements on the list of desired elements that have changed since a previous backup;
initiating a transfer of desired elements that have changed since the previous backup;
a backup storage device comprising a processor and instructions, stored on persistent storage, that when executed by the processor, cause the backup storage device to:
receive the desired elements that have changed since the previous backup;
store the elements on the list of desired elements that have changed since the previous backup in a backup container;
determine a list of unchanged elements from the previous backup; and
storing unchanged elements on the list of unchanged elements in the backup container to obtain a tailored synthetic backup.

10. The system of claim 9, wherein determining the elements on the list of desired elements that have changed since a previous backup comprises:
receiving, from the production host, a list of changed elements; and
determine the elements on the list of desired elements that have changed by comparing the list of desired elements to the list of changed elements.

11. The system of claim 9, wherein determining the elements on the list of desired elements that have changed since the previous backup comprises:
obtaining current metadata associated with each of the elements on the list of desired elements; and
comparing the current metadata for each element on the list of desired elements to metadata for each element in the previous backup.

12. The system of claim 11, wherein the metadata comprises at least one selected from a group consisting of attribute information, location information, and hash information.

13. The system of claim 12, wherein the hash information is used to determine elements on the list of desired elements that have changed since the previous backup.

14. The system of claim 9, wherein the previous back up is a most recent successful full backup.

15. A non-transitory computer readable medium comprising computer readable program code, which when executed by a computer processor enables the computer processor to perform a method for hybrid incremental file-based backup, the method comprising:
receiving a list of desired elements for incremental backup;
determining elements on the list of desired elements that have changed since a previous backup;
storing the elements on the list of desired elements that have changed since the previous backup in a backup container;
determining a list of unchanged elements from the previous backup; and
storing unchanged elements on the list of unchanged elements in the backup container to obtain an updated full backup.

16. The computer readable medium of claim 15, wherein determining the elements on the list of desired elements that have changed since a previous backup comprises:
receiving a list of changed elements; and
determine the elements on the list of desired elements that have changed by comparing the list of desired elements to the list of changed elements.

17. The computer readable medium of claim 15, wherein determining the elements on the list of desired elements that have changed since a previous backup comprises:
obtaining current metadata associated with each of the elements on the list of desired elements; and
comparing the current metadata for each element on the list of desired elements to metadata for each element in the previous backup.

18. The computer readable medium of claim 17, wherein the metadata comprises at least one selected from a group consisting of attribute information, location information, and hash information.

19. The computer readable medium of claim 18, wherein the hash information is used to determine elements on the list of desired elements that have changed since the previous backup.

20. The computer readable medium of claim 15, wherein the previous back up is a most recent successful full backup.
